(19) United States
(12) Patent Application Publication
(10) Pub. No.: US 2020/0002531 A1
(43) Pub. Date: Jan. 2, 2020

(54) COPOLYCARBONATE COMPOSITIONS INCLUDING 2-HYDROCARBYL-3-(DIHYDROXYFLUORESCEINYL)PHTHALIMIDINE UNIT, AND ARTICLES DERIVED THEREFROM

(71) Applicant: SABIC GLOBAL TECHNOLOGIES B.V., Bergen Op Zoom (NL)

(72) Inventors: Lohith KENCHAIAH, Bangalore (IN); James Alan Mahood, Mt. Vernon, IN (US); Vijayakumar Venkatesh SUGUR, Marathalli (IN); Gurunath Pozhal VENGU, Bangalore (IN); Hariharan RAMALINGAM, Bangalore (IN); Jaykisor PAL, Bangalore (IN); Mukesh AGRAWAL, Bangalore (IN)

(21) Appl. No.: 16/446,154

(22) Filed: Jun. 19, 2019

(30) Foreign Application Priority Data
Jun. 29, 2018 (EP) EP18181025.0

(51) Int. Cl. C08L 69/00; C08G 64/12; C08K 5/00

(52) U.S. Cl. CPC C08L 69/00; C08G 64/12; C08L 63/00; C08K 5/0066; C08L 2201/02; C08K 5/005

(57) ABSTRACT

A thermoplastic composition comprising a copolycarbonate comprising bisphenol A carbonate units and second carbonate units of formula (1a)

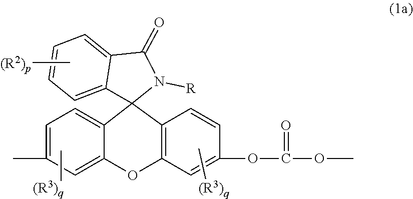

wherein R is a C₁₋₂₅ hydrocarbyl; each occurrence of R² and R³ is independently a halogen or a C₁₋₂₅ hydrocarbyl; p is 0 to 4; and each q is independently 0 to 3; and optionally a bisphenol A homopolycarbonate.

### BACKGROUND

This disclosure relates to polycarbonate compositions, and more particularly compositions including copolycarbonates having structural units derived from 2-hydrocarbyl-3-(dihydroxyfluoresceinyl)phthalimidines, and articles derived therefrom.

Polycarbonates are useful in the manufacture of articles and components for a wide range of applications, from automotive parts to electronic appliances. Because of their broad use, particularly in lenses, optical films, and healthcare products requiring high heat sterilization, it is desirable to provide polycarbonates with high heat performance combined with good optical properties, particularly after processing and after exposure to real life conditions such as prolonged exposure to high temperatures.

Some known “high heat” copolycarbonates can have high glass transition temperatures of 150° C. or higher. But such polycarbonates are typically more yellow after processing and have lower transmission values. There accordingly remains a need for polycarbonate and copolycarbonate compositions having an improved balance of high heat performance, optical properties, and mechanical properties.

### BRIEF DESCRIPTION

Provided is a thermoplastic composition including a copolycarbonate comprising bisphenol A carbonate units and second carbonate units of formula (1a)

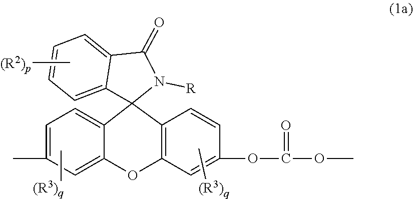

wherein R is a C₁₋₂₅ hydrocarbyl, preferably a C₁₋₆ alkyl, a phenyl, or a phenyl substituted with up to five C₁₋₆ alkyl groups, more preferably a C₁₋₃ alkyl or a phenyl; each occurrence of R² and R³ is independently a halogen or a C₁₋₂₅ hydrocarbyl, preferably a halogen or a C₁₋₆ alkyl, more preferably a C₁₋₃ alkyl; p is 0 to 4, preferably 0 or 1, more preferably 0; and each q is independently 0 to 3, preferably 0 or 1, more preferably 0; and optionally a bisphenol A homopolycarbonate.

Also provided is an article manufactured from the thermoplastic composition, wherein the article is a molded article, a thermoformed article, an extruded film, an extruded sheet, one or more layers of a multi-layer article, a three dimensional printed part, a substrate for a coated article, or a substrate for a metallized article.

The above described and other features are exemplified by the following figures and detailed description.

### DETAILED DESCRIPTION

The present disclosure is generally directed to polymers and copolymer comprising a 2-hydrocarbyl-3-(dihydroxyfluoresceinyl)phthalimidine repeating unit and the corresponding articles derived therefrom. The copolymers including the 2-hydrocarbyl-3-(dihydroxyfluoresceinyl)phthalimidines can have improved properties, such as high heat stability, good color stability, and a reduced yellowness index (YI). The 2-hydrocarbyl-3-(dihydroxyfluoresceinyl)phthalimidine precursor monomers can be prepared with high purity and can provide a high product purity as compared to previous monomers such as 2-hydrocarbyl-3,3-bis(4-hydroxyaryl)phthalimidines.

The thermoplastic composition includes a copolycarbonate comprising bisphenol A carbonate repeating units and second carbonate repeating units derived from a 2-hydrocarbyl-3-(dihydroxyfluoresceinyl)phthalimidine bisphenol monomer. As used herein, the second carbonate repeating units are phthalimidine carbonate units. The term “repeating unit”, as used herein, is synonymous with “unit”.

In the thermoplastic composition, the copolycarbonate can be present in an amount of 10 wt % to 99 wt %, 90 wt % to 99.8 wt %, 20 wt % to 80 wt %, 40 wt % to 70 wt %, or 50 wt % to 70 wt %, based on the total weight of the thermoplastic composition.

“Polycarbonate” as used herein means a homopolymer or copolymer having repeating structural carbonate units of formula (1)

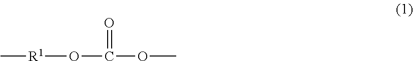

wherein at least 60 percent of the total number of R¹ groups contain aromatic moieties and the balance thereof are aliphatic, alicyclic, or aromatic. “Copolycarbonates” include copolymers comprising different R¹ moieties in the carbonate, and copolymers comprising different carbonate units and other types of polymer units, such as ester units or siloxane units.

Each R¹ can be a C₆₋₃₀ aromatic group, that is, contains at least one aromatic moiety. Exemplary R¹ groups can be derived from an aromatic dihydroxy compound of the formula HO—R¹—OH, in particular of formula (2)

HO-A¹-Y¹-A²-OH (2)

wherein each of A¹ and A² is a monocyclic divalent aromatic group and Y¹ is a single bond or a bridging group having one or more atoms that separate A¹ from A², or for example one atom separates A¹ from A². Specifically, each R¹ can be derived from a bisphenol of formula (3)

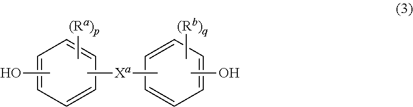

wherein R^{a} and R^{b} each represent a halogen or C₁₋₁₂ alkyl group and can be the same or different; and p and q are each independently integers of 0 to 4. It will be understood that when p or q is less than 4, the valence of each carbon of the ring is filled by hydrogen. X^{a} represents a single bond or a bridging group connecting the two hydroxy-substituted aromatic groups, where the single bond or the bridging group and the hydroxy substituent of each C₆ arylene group are disposed ortho, meta, or para (specifically para) to each other on the C₆ arylene group. For example, the bridging group X^{a} can be —O—, —S—, —S(O)—, —S(O)₂—, —C(O)—, or a C₁₋₁₈ organic group. The C₁₋₁₈ organic group can be cyclic or acyclic, aromatic or non-aromatic, and can further include heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic group. In some aspects, p and q is each 1, and R^{a} and R^{b} are each a C₁₋₃ alkyl group, specifically methyl, disposed meta to the hydroxy group on each arylene group.

The group X^{a} can be a substituted or unsubstituted C₃₋₁₈ cycloalkylidene, a C₁₋₂₅ alkylidene of formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})— wherein R^{e} is a divalent C₁₋₁₂ hydrocarbon group. Exemplary groups of this type include methylene, cyclohexylmethylene, ethylidene, neopentylidene, and isopropylidene, as well as 2-[2.2.1]-bicycloheptylidene, cyclohexylidene, cyclopentylidene, cyclododecylidene, and adamantylidene. Alternatively, the group X^{a} can be a C₁₋₁₈ alkylene group, a C₃₋₁₈ cycloalkylene group, a fused C₆₋₁₈ cycloalkylene group, or a group of the formula —B¹—W—B²— wherein B¹ and B² are the same or different C₁₋₆ alkylene group and W is a C₃₋₁₂ cycloalkylidene group or a C₆₋₁₆ arylene group.

Other exemplary dihydroxy compounds of the formula HO—R¹—OH include aromatic dihydroxy compounds of formula (4)

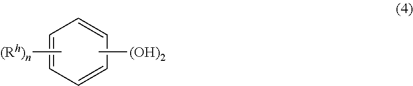

wherein each R^{h} is independently a halogen atom, C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4.

Exemplary aromatic dihydroxy compounds include 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or combinations thereof.

The aromatic dihydroxy compound can be a bisphenol, such as 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 1,1-bis(4-hydroxy-3-methylphenyl)cyclohexane (DMBPC), or a combination thereof. For example, the polycarbonate can be a linear homopolymer derived from BPA, wherein A¹ and A² are p-phenylene and Y¹ is isopropylidene.

The copolycarbonate includes a bisphenol A carbonate unit that is derived from 2,2-bis(4-hydroxyphenyl) propane (BPA) and has the formula (5)

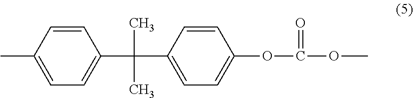

The phthalimidine carbonate unit includes second carbonate units, which are 2-hydrocarbyl-3-(dihydroxyfluoresceinyl)phthalimidine units, of formula (1a)

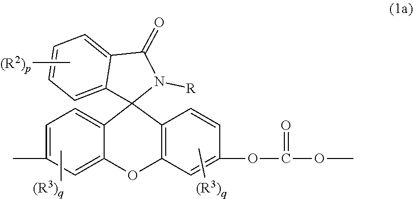

that are derived from a 2-hydrocarbyl-3-(dihydroxyfluoresceinyl)phthalimidine bisphenol monomer of the formula (6)

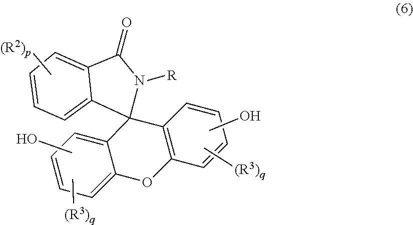

wherein, in formulas (1a) and (6), R is a C₁₋₂₅ hydrocarbyl, preferably a C₁₋₆ alkyl, a phenyl, or a phenyl substituted with up to five C₁₋₆ alkyl groups, more preferably a C₁₋₃ alkyl or a phenyl. Each occurrence of R² and R³ is independently a halogen or a C₁₋₂₅ hydrocarbyl, preferably a halogen or a C₁₋₆ alkyl, more preferably a C₁₋₃ alkyl, p is 0 to 4, and each q is independently 0 to 3. In some aspects, R is a C₁₋₆ alkyl, a phenyl, or a phenyl substituted with up to five C₁₋₆ alkyl groups. For example, R can be a C₁₋₃ alkyl or a phenyl. In some aspects, R² and R³ are each independently a halogen or a C₁₋₆ alkyl, and p and q are each independently 0 to 3. For example, R² and R³ each can be independently the same or different C₁₋₃ alkyl, and p and q are each independently 0 to 3. In some aspects, p and q are each independently 0 or 1. For example, p can be 1 and R² can be a C₁₋₃ alkyl group. In still other aspects, p and q are each 0.

The second carbonate units can be of formula (1b)

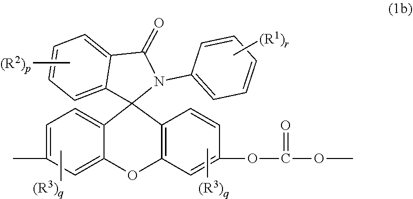

wherein each occurrence of R¹ is independently a phenyl or a C₁₋₆ alkyl; p is 0 to 4, q is 0 to 3, and r is 0 to 5, preferably 0 or 1. Each occurrence of R² and R³ is independently a halogen or a C₁₋₂₅ hydrocarbyl, preferably a halogen or a C₁₋₆ alkyl, more preferably a C₁₋₃ alkyl; and q are each independently 0 to 3, preferably 0 or 1, more preferably 0. In some aspects, R¹ is a C₁₋₃ alkyl and r is 0 or 1. In certain aspects, R² and R³ each can be independently a C₁₋₃ alkyl, and p and q are each independently 0 or 1. In some aspects, r is 0. In other aspects, p is 0.

For example, when p, q, and r are 0, the second carbonate unit is of formula (1c)

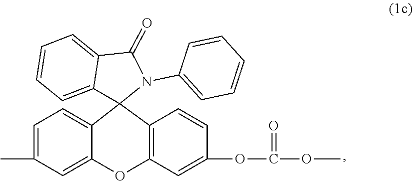

which can be prepared from 2-phenyl-3-(dihydroxyfluoresceinyl)phthalimidine (RPBP) by the methods described herein.

The copolycarbonate can include 5-95 mole percent (mol %), of the bisphenol A carbonate units and 5-95 mol % of the second carbonate units, preferably 25-85 mol % of the bisphenol A carbonate units and 15-75 mol % of the second carbonate units, and more preferably 50-80 mol % of the bisphenol A carbonate units and 20-50 mol % of the second carbonate units, based on the total number of carbonate units in the copolycarbonate.

The copolycarbonate can further include a high heat carbonate unit different from the bisphenol A carbonate unit and the second carbonate unit. The high heat carbonate unit can be one or more of the formulas (7) to (11):

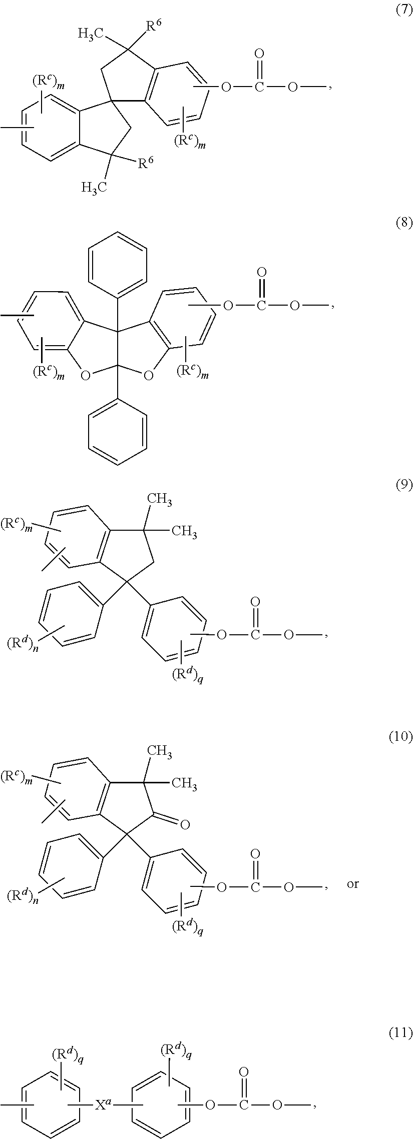

wherein R^{c} and R^{d} are each independently a C₁₋₁₂ alkyl, C₁₋₁₂ alkenyl, C₃₋₈ cycloalkyl, or C₁₋₁₂ alkoxy, each R⁶ is independently C₁₋₃ alkyl or phenyl, preferably methyl, X^{a} is a C₆₋₁₂ polycyclic aryl, C₃₋₁₈ mono- or polycycloalkylene, C₃₋₁₈ mono- or polycycloalkylidene, -(Q¹)ₓ-G-(Q²)_{y}-group wherein Q¹ and Q² are each independently a C₁₋₃ alkylene, G is a C₃₋₁₀ cycloalkylene, x is 0 or 1, and y is 1, or —C(P¹)(P²)— wherein P¹ is C₁₋₁₂ alkyl and P² is C₆₋₁₂ aryl; each m is independently 0 to 3; preferably 0 or 1, more preferably 0; each n is independently 0 to 5; preferably 0 or 1, more preferably 0; and each q is independently 0 to 4; preferably 0 or 1, more preferably 0.

Exemplary high heat carbonate units include the following:

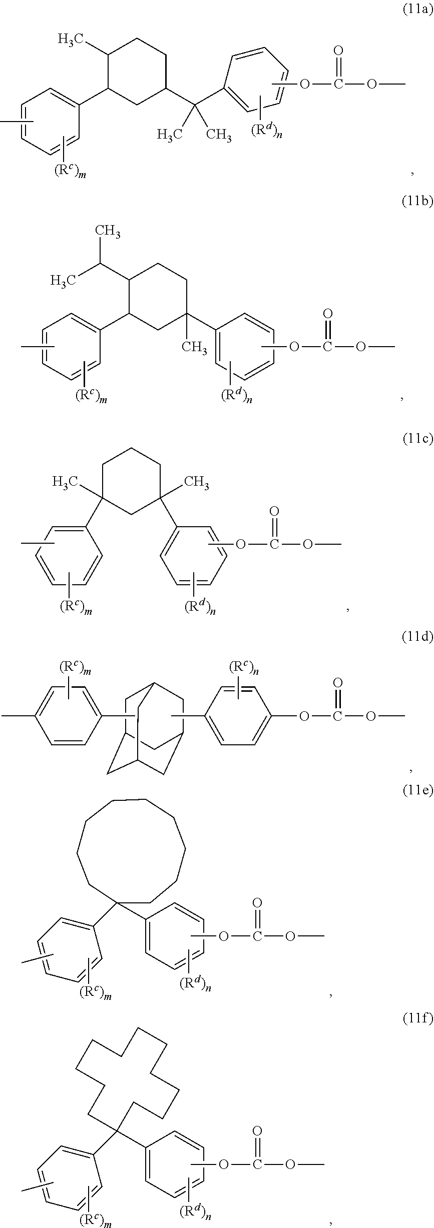

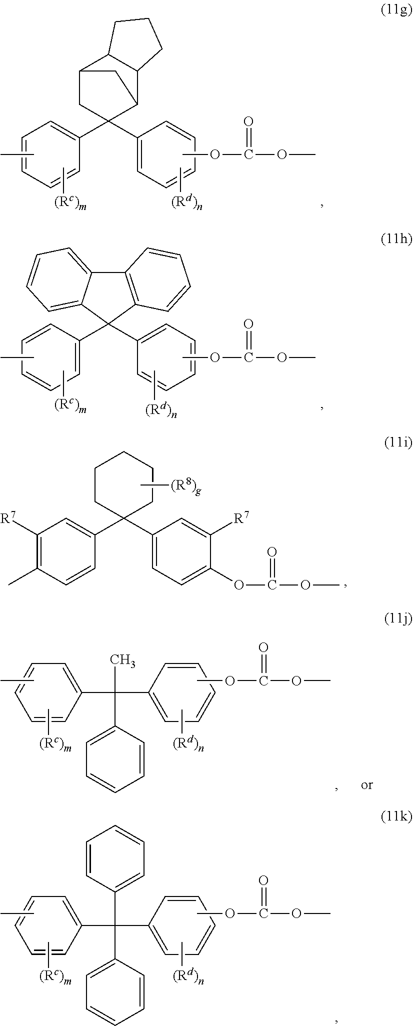

wherein R^{c} and R^{d} are as defined for formula (11), each R⁷ is independently hydrogen or C₁₋₄ alkyl, each R⁸ is independently a C₁₋₄ alkyl, g is 0 to 10, and m and n are each independently 0 to 4. Preferably, each R⁷ is independently methyl, each R⁸ is independently methyl, g is 0 to 2, and m and n are 0. In an aspect, the thermoplastic composition does not include 2-phenyl-3,3-bis(4-hydroxyphenyl)phthalimide.

When the high heat carbonate units are present, the copolycarbonate can include 40-80 mol % of the bisphenol A carbonate units, 10-50 mol % of the second carbonate units, and 5-50 mol % of the high heat carbonate units, preferably 50-80 mol % of the bisphenol A carbonate units, 20-50 mol % of the second carbonate units, and 5-40 mol % of the high heat carbonate units, more preferably 50-70 mol % of the bisphenol A carbonate units, 20-40 mol % of the second carbonate units, and 5-30 mol % of the high heat carbonate units, based on the total number of carbonate units in the copolycarbonate.

The copolycarbonate can be random copolymers, which have less than 15 mol % or less than 10 mol % of the second carbonate units directly coupled to another second carbonate unit based on the total number of carbonate units in the copolycarbonate.

The copolycarbonate can be polycarbonate copolymer that includes carbonate repeating units and non-carbonate repeating units. A specific type of copolymer is a poly(ester-carbonate), also known as a polyester-polycarbonate. Such copolymers further contain, in addition to recurring carbonate units of formula (1), repeating units of formula (12)

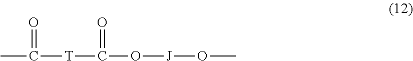

wherein each J is a divalent group derived from a dihydroxy compound (including a reactive derivative thereof), and can be, for example, a C₁₋₁₀ alkylene, a C₆₋₂₀ cycloalkylene, a C₅₋₂₀ arylene, or a polyoxyalkylene in which the alkylene groups contain 2 to 6 carbon atoms, specifically 2, 3, or 4 carbon atoms; and each T is a divalent group derived from a dicarboxylic acid (including a reactive derivative thereof), and can be, for example, a C₂₋₂₀ alkylene, a C₅₋₂₀ cycloalkylene, or a C₆₋₂₀ arylene. The polyester units can be branched or linear.

For example, J can be a C₂₋₃₀ alkylene group having a straight chain, branched chain, or cyclic (including polycyclic) structure, such as n-propylene, i-proplyene, 1,4-butylene, 1,4-cyclohexylene, or 1,4-methylenecyclohexane. The group J can be derived from a bisphenol of formula (3), e.g., bisphenol A, or an aromatic dihydroxy compound of formula (4), e.g., resorcinol.

Aromatic dicarboxylic acids that can be used to prepare the polyester units include isophthalic or terephthalic acid, 1,2-di(p-carboxyphenyl)ethane, 4,4′-dicarboxydiphenyl ether, 4,4′-bisbenzoic acid, or a combination thereof. Acids containing fused rings can also be present, such as in 1,4-, 1,5-, or 2,6-naphthalenedicarboxylic acids. Specific dicarboxylic acids include terephthalic acid, isophthalic acid, naphthalene dicarboxylic acid, 1,4-cyclohexane dicarboxylic acid, or a combination thereof. A specific dicarboxylic acid comprises a combination of isophthalic acid and terephthalic acid in a weight ratio of 91:9 to 2:98.

Exemplary ester units include ethylene terephthalate, n-propylene terephthalate, n-butylene terephthalate, 1,4-cyclohexanedimethylene terephthalate, and ester units derived from isophthalic acid, terephthalic acid, and resorcinol (ITR)). The molar ratio of ester units to carbonate units in the copolymers can vary broadly, for example 1:99 to 99:1, specifically 10:90 to 90:10, more specifically 25:75 to 75:25, or 2:98 to 15:85. Specific poly(ester-carbonate)s are those including bisphenol A carbonate units and isophthalate-terephthalate-bisphenol A ester units such as poly(carbonate-ester)s (PCE) or poly(phthalate-carbonate)s (PPC).

The copolycarbonates can further include polysiloxane blocks that comprise repeating diorganosiloxane units as in formula (13)

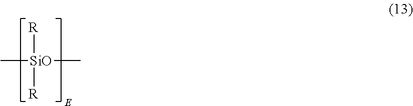

wherein each R is independently a C₁₋₁₃ monovalent organic group. For example, R can be a C₁₋₁₃ alkyl, C₁₋₁₃ alkoxy, C₂₋₁₃ alkenyl, C₂₋₁₃ alkenyloxy, C₃₋₆ cycloalkyl, C₃₋₆ cycloalkoxy, C₆₋₁₄ aryl, C₆₋₁₀ aryloxy, C₇₋₁₃ arylalkyl, C₇₋₁₃ aralkoxy, C₇₋₁₃ alkylaryl, or C₇₋₁₃ alkylaryloxy, each group optionally fully or partially halogenated. E has an average value of 2 to 1,000, specifically 2 to 500, 2 to 200, or 2 to 125, 5 to 80, or 10 to 70.

For example, the polysiloxane blocks can be of formula (14)

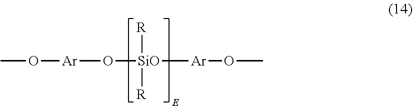

wherein E is as defined above; each R can be the same or different, and is as defined above; and Ar can be the same or different, and is a substituted or unsubstituted C₆₋₃₀ arylene, wherein the bonds are directly connected to an aromatic moiety. Ar groups in formula (14) can be derived from a C₆₋₃₀ dihydroxyarylene compound, for example a dihydroxyarylene compound of formula (3) or (4) above.

Other exemplary polysiloxane blocks can be of formula (15)

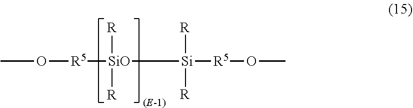

wherein R and E are as described above, and each R⁵ is independently a divalent C₁₋₃₀ organic group, and wherein the polymerized polysiloxane unit is the reaction residue of its corresponding dihydroxy compound. For example, polysiloxane blocks can be of formula (16)

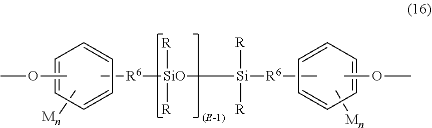

wherein R and E are as defined above, R⁶ is a divalent C₂₋₈ aliphatic, each M is the same or different, and can be a halogen, cyano, nitro, C₁₋₈ alkylthio, C₁₋₈ alkyl, C₁₋₈ alkoxy, C₂₋₈ alkenyl, C₂₋₈ alkenyloxy, C₃₋₈ cycloalkyl, C₃₋₈ cycloalkoxy, C₆₋₁₀ aryl, C₆₋₁₀ aryloxy, C₇₋₁₂ aralkyl, C₇₋₁₂ aralkoxy, C₇₋₁₂ alkylaryl, or C₇₋₁₂ alkylaryloxy, and each n is independently 0, 1, 2, 3, or 4.

Specific polysiloxane blocks are of the formulas (16a) to (16c)

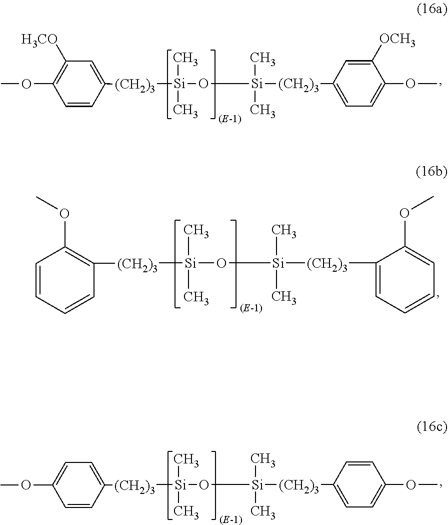

wherein E has an average value of 2 to 200, 5 to 125, 5 to 100, 5 to 50, 20 to 80, or 5 to 20.

Blocks of formula (16) can be derived from the corresponding dihydroxy polysiloxane, which in turn can be prepared effecting a platinum-catalyzed addition between the siloxane hydride and an aliphatically unsaturated monohydric phenol. The poly(carbonate-siloxane) copolymers can then be manufactured, for example, by the synthetic procedure of European Patent Application Publication No. 0 524 731 A1 of Hoover, page 5, Preparation 2.

Polyorganosiloxane-polycarbonates can have a weight average molecular weight of 2,000 to 100,000 Da, specifically 5,000 to 50,000 Da as measured by GPC using a crosslinked styrene-divinyl benzene column, at a sample concentration of 1 milligram per milliliter, and as calibrated with polystyrene standards.

Polycarbonates and polycarbonate copolymers can be manufactured by processes such as interfacial polymerization and melt polymerization. Although the reaction conditions for interfacial polymerization can vary, an exemplary process generally involves dissolving or dispersing a dihydroxy compound in aqueous NaOH or KOH, adding the resulting mixture to a water-immiscible solvent, and contacting the reactants with a carbonate precursor in the presence of a catalyst such as, for example, a tertiary amine or a phase transfer catalyst, under controlled pH conditions, e.g., 8 to 10. The water-immiscible solvent can be, for example, methylene chloride, 1,2-dichloroethane, chlorobenzene, toluene, or the like.

The carbonate precursor can be a carbonyl halide, a bishaloformate of a dihydroxy compound, or a diaryl carbonate. The carbonyl halide can be carbonyl bromide or carbonyl chloride (phosgene). The bischloroformate can be the bischloroformate of bisphenol A, hydroquinone, ethylene glycol, neopentyl glycol, or the like. The diaryl carbonate can be a diaryl carbonate of formula (17)

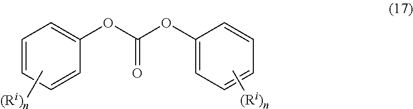

wherein n is an integer 1 to 3 and each R′ is independently a linear or branched, optionally substituted C₁₋₃₄ alkyl, C₁₋₃₄ alkoxy, C₅₋₃₄ cycloalkyl, C₇₋₃₄ alkylaryl, C₆₋₃₄ aryl, a halogen, or —C(═O)OR′ wherein R′ is H, linear or branched C₁₋₃₄ alkyl, C₁₋₃₄ alkoxy, C₅₋₃₄ cycloalkyl, C₇₋₃₄ alkylaryl, or C₆₋₃₄ aryl. For example, the diaryl carbonate can be diphenyl carbonate, bis(4-nitrophenyl)carbonate, bis(2-chlorophenyl)carbonate, bis(4-chlorophenyl)carbonate, bis(methyl salicyl)carbonate (BMSC), bis(4-methylcarboxylphenyl) carbonate, bis(2-acetylphenyl) carboxylate, or bis(4-acetylphenyl) carboxylate. A molar ratio of diaryl carbonate to dihydroxy compound can be 2:1 to 1:2, or 1.5:1 to 1:1.5, or 1.05:1 to 1:1.05, or 1:1.

In the manufacture of poly(ester-carbonate)s by interfacial polymerization, rather than using the dicarboxylic acid or diol directly, the reactive derivatives of the diacid or diol, such as the corresponding acid halides, in particular the acid dichlorides and the acid dibromides can be used. Thus, for example instead of using isophthalic acid, terephthalic acid, or a combination comprising at least one of the foregoing acids, isophthaloyl dichloride, terephthaloyl dichloride, or a combination comprising at least one of the foregoing dichlorides can be used.

Among tertiary amines that can be used as catalysts in interfacial polymerization are aliphatic tertiary amines such as triethylamine and tributylamine, cycloaliphatic tertiary amines such as N,N-diethyl-cyclohexylamine, and aromatic tertiary amines such as N,N-dimethylaniline. Among the phase transfer catalysts that can be used are catalysts of the formula (R³)₄Q⁺X, wherein each R³ is the same or different, and is a C₁₋₁₀ alkyl; Q is a nitrogen or phosphorus atom; and X is a halogen atom or a C₁₋₈ alkoxy or C₆₋₁₈ aryloxy. Exemplary phase transfer catalysts include (CH₃(CH₂)₃)₄NX, (CH₃(CH₂)₃)₄PX, (CH₃(CH₂)₅)₄NX, (CH₃(CH₂)₆)₄NX, (CH₃(CH₂)₄)₄NX, CH₃(CH₃(CH₂)₃)₃NX, and CH₃(CH₃(CH₂)₂)₃NX, wherein X is Cl⁻, Br⁻, a C₁₋₈ alkoxy or a C₆₋₁₈ aryloxy. An effective amount of a phase transfer catalyst can be 0.1 to 10 wt %, or 0.5 to 2 wt %, each based on the weight of dihydroxy compound.

Alternatively, melt processes can be used to make the polycarbonates. Generally, in the melt polymerization process, polycarbonates can be prepared by co-reacting, in a molten state, a dihydroxy reactant and a diaryl carbonate ester in the presence of a transesterification catalyst. The reaction can be carried out in typical polymerization equipment, such as a continuously stirred reactor (CSTR), plug flow reactor, wire wetting fall polymerizers, free fall polymerizers, wiped film polymerizers, BANBURY mixers, single or twin screw extruders, or a combination of the foregoing. Volatile monohydric phenol is removed from the molten reactants by distillation and the polymer is isolated as a molten residue. Melt polymerization can be conducted as a batch process or as a continuous process. In either case, the melt polymerization conditions used can comprise two or more distinct reaction stages, for example, a first reaction stage in which the starting dihydroxy aromatic compound and diaryl carbonate are converted into an oligomeric polycarbonate and a second reaction stage wherein the oligomeric polycarbonate formed in the first reaction stage is converted to high molecular weight polycarbonate. Such “staged” polymerization reaction conditions are especially suitable for use in continuous polymerization systems wherein the starting monomers are oligomerized in a first reaction vessel and the oligomeric polycarbonate formed therein is continuously transferred to one or more downstream reactors in which the oligomeric polycarbonate is converted to high molecular weight polycarbonate. Typically, in the oligomerization stage the oligomeric polycarbonate produced has a number average molecular weight of 1,000 to 7,500 Daltons (Da). In one or more subsequent polymerization stages the number average molecular weight (Mn) of the polycarbonate is increased to between 8,000 and 25,000 Da (using polycarbonate standard). Typically, solvents are not used in the process, and the reactants dihydroxy aromatic compound and the diaryl carbonate are in a molten state. The reaction temperature can be 100 to 350° C., specifically 180 to 310° C. The pressure can be at atmospheric pressure, supra-atmospheric pressure, or a range of pressures from atmospheric pressure to 15 torr in the initial stages of the reaction, and at a reduced pressure at later stages, for example 0.2 to 15 torr. The reaction time is generally 0.1 hours to 10 hours.

Catalysts used in the melt transesterification polymerization production of polycarbonates can include alpha or beta catalysts. Beta catalysts are typically volatile and degrade at elevated temperatures. Beta catalysts are therefore preferred for use at early low-temperature polymerization stages. Alpha catalysts are typically more thermally stable and less volatile than beta catalysts.

The alpha catalyst can include a source of alkali or alkaline earth ions. The sources of these ions include alkali metal hydroxides such as lithium hydroxide, sodium hydroxide, and potassium hydroxide, as well as alkaline earth hydroxides such as magnesium hydroxide and calcium hydroxide. Other possible sources of alkali and alkaline earth metal ions include the corresponding salts of carboxylic acids (such as sodium acetate) and derivatives of ethylene diamine tetraacetic acid (EDTA) (such as EDTA tetrasodium salt, and EDTA magnesium disodium salt). Exemplary alpha transesterification catalysts include alkali or alkaline earth metal salts of carbonate, such as Cs₂CO₃, NaHCO₃, and Na₂CO₃, and the like, non-volatile inorganic acid such as NaH₂PO₃, NaH₂PO₄, Na₂HPO₃, KH₂PO₄, CsH₂PO₄, Cs₂HPO₄, and the like, or mixed salts of phosphoric acid, such as NaKHPO₄, CsNaHPO₄, CsKHPO₄, or the like, or combinations thereof.

Exemplary beta catalysts can include a quaternary ammonium compound, a quaternary phosphonium compound, or a combination comprising at least one of the foregoing. The quaternary ammonium compound can be a compound of the structure (R⁴)₄N⁺X⁻, wherein each R⁴ is the same or different, and is a C₁₋₂₀ alkyl, a C₄₋₂₀ cycloalkyl, or a C₄₋₂₀ aryl; and X⁻ is an organic or inorganic anion, for example a hydroxide, halide, carboxylate, sulfonate, sulfate, formate, carbonate, or bicarbonate. Exemplary quaternary ammonium compounds include tetramethyl ammonium hydroxide, tetrabutyl ammonium hydroxide, tetramethyl ammonium acetate, tetramethyl ammonium formate, tetrabutyl ammonium acetate, or a combination thereof. The quaternary phosphonium compound can be a compound of the structure (R⁵)₄P⁺X⁻, wherein each R⁵ is the same or different, and is a C₁₋₂₀ alkyl, a C₄₋₂₀ cycloalkyl, or a C₄₋₂₀ aryl; and X⁻ is an organic or inorganic anion, for example a hydroxide, phenoxide, halide, carboxylate such as acetate or formate, sulfonate, sulfate, formate, carbonate, or bicarbonate. Where X⁻ is a polyvalent anion such as carbonate or sulfate it is understood that the positive and negative charges in the quaternary ammonium and phosphonium structures are properly balanced. For example, where R⁴ or R⁵ are each methyl and X⁻ is carbonate, it is understood that X⁻ represents ½(CO₃⁻²). Exemplary quaternary phosphonium compounds include tetramethyl phosphonium hydroxide, tetramethyl phosphonium acetate, tetramethyl phosphonium formate, tetrabutyl phosphonium hydroxide, tetrabutyl phosphonium acetate (TBPA), tetraphenyl phosphonium acetate, tetraphenyl phosphonium phenoxide, or a combination thereof.

The amount of alpha and beta catalyst used can be based upon the total number of moles of dihydroxy compound used in the polymerization reaction. When referring to the ratio of beta catalyst, for example, a phosphonium salt, to all dihydroxy compounds used in the polymerization reaction, it is convenient to refer to moles of phosphonium salt per mole of the dihydroxy compound, meaning the number of moles of phosphonium salt divided by the sum of the moles of each individual dihydroxy compound present in the reaction mixture. The alpha catalyst can be used in an amount sufficient to provide 1×10⁻² to 1×10⁻⁸ moles, specifically, 1×10⁻⁴ to 1×10⁻⁷ moles of metal per mole of the dihydroxy compounds used. The amount of beta catalyst can be 1×10⁻² to 1×10⁻⁵, specifically 1×10⁻³ to 1×10⁻⁴ moles per total mole of the dihydroxy compounds in the reaction mixture. Quenching of the transesterification catalysts and any reactive catalysts residues with an acidic compound after polymerization is completed can also be useful in some melt polymerization processes. Removal of catalyst residues or quenching agent and other volatile residues from the melt polymerization reaction after polymerization is completed can also be useful in some melt polymerization processes

An end-capping agent (i.e., a chain stopper agent or chain terminating agent) can be included during polymerization to provide end groups. Exemplary end-capping agents include monocyclic phenols such as phenol and C₁₋₂₂ alkyl-substituted phenols such as p-cumyl-phenol, resorcinol monobenzoate, and p- and tertiary-butyl phenol, monoethers of diphenols, such as p-methoxyphenol, and alkyl-substituted phenols with branched chain alkyl substituents having 8 to 9 carbon atoms, 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, mono-carboxylic acid chlorides such as benzoyl chloride, C₁₋₂₂ alkyl-substituted benzoyl chloride, toluoyl chloride, bromobenzoyl chloride, cinnamoyl chloride, and 4-nadimidobenzoyl chloride, polycyclic, mono-carboxylic acid chlorides such as trimellitic anhydride chloride, and naphthoyl chloride, functionalized chlorides of aliphatic monocarboxylic acids, such as acryloyl chloride and methacryoyl chloride, and mono-chloroformates such as phenyl chloroformate, alkyl-substituted phenyl chloroformates, p-cumyl phenyl chloroformate, toluene chloroformate, or a combinations of end-capping agents.

Branched polycarbonate blocks can be prepared by adding a branching agent during polymerization, such as polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxyphenylethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents can be added at a level of 0.05 to 2.0 wt %.

The copolycarbonate can be essentially free of certain metal cations, anions, and low molecular weight molecules (less than 150 g/mol). For example, the copolycarbonate can include less than 2 ppm by weight of each of triethyl amine, calcium cations, magnesium cations, potassium cations, iron cations, and chloride anions.

The copolycarbonate can have a weight average molecular weight (Mw) of 10,000 to 50,000 Daltons (Da), preferably 16,000 to 30,000 (Da), more preferably 18,000 to 35,000, as measured by gel permeation chromatography (GPC), using a crosslinked styrene-divinylbenzene column and calibrated to polystyrene references.

The copolycarbonate can have a polydispersity index of 1 to 10, preferably 1.5 to 8, more preferably 1.5 to 4.

The copolycarbonate can have a high glass transition temperature (T_{g}) that is 150° C. or greater, preferably 190° C. or greater, more preferably 195° C. or greater, as determined by differential scanning calorimetry (DSC) as per ASTM D3418 with a 20° C./min heating rate. For example, the T_{g} can be 150 to 280° C., preferably 160 to 260° C., more preferably 170 to 230° C., even more preferably 180 to 230° C. or 190 to 230° C.

The heat deflection temperature (HDT) of the copolycarbonate can be 145 to 270° C., more preferably 155 to 260° C., even more preferably 175 to 220° C., measured flat on a 80×10×4 mm bar with a 64 mm span at 0.45 MPa according to ISO 75/Bf.

The copolycarbonate have a Vicat B120 of 150 to 275° C., preferably 160 to 255° C., even more preferably 180 to 225° C., measured according to ISO 306.

A thermoplastic polymer different from the copolycarbonate can be present. Examples of thermoplastic polymers that can be used include polyacetals (e.g., polyoxyethylene and polyoxymethylene), poly(C₁₋₆ alkyl)acrylates, polyacrylamides, polyamides, (e.g., aliphatic polyamides, polyphthalamides, and polyaramides), polyamideimides, polyanhydrides, polyarylates, polyarylene ethers (e.g., polyphenylene ethers), polyarylene sulfides (e.g., polyphenylene sulfides), polyarylene sulfones (e.g., polyphenylene sulfones), polybenzothiazoles, polybenzoxazoles, polycarbonates (including polycarbonate copolymers such as polycarbonate-siloxanes, polycarbonate-esters, and polycarbonate-ester-siloxanes), polyesters (e.g., polyethylene terephthalates, polybutylene terephthalates, polyarylates, and polyester copolymers such as polyester-ethers), polyetheretherketones, polyetherimides (including copolymers such as polyetherimide-siloxane copolymers), polyetherketoneketones, polyetherketones, polyethersulfones, polyimides (including copolymers such as polyimide-siloxane copolymers), poly(C₁₋₆ alkyl)methacrylates, polymethacrylamides, polynorbornenes (including copolymers containing norbornenyl units), polyolefins (e.g., polyethylenes, polypropylenes, polytetrafluoroethylenes, and their copolymers, for example ethylene-alpha-olefin copolymers), polyoxadiazoles, polyoxymethylenes, polyphthalides, polysilazanes, polysiloxanes, polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, polyvinyl alcohols, polyvinyl esters, polyvinyl ethers, polyvinyl halides, polyvinyl ketones, polyvinyl thioethers, polyvinylidene fluorides, or the like, or a combination thereof.

The thermoplastic composition can further include a bisphenol A homopolycarbonate. The bisphenol A homopolycarbonate can be derived from a bisphenol A monomer having a purity less than 99.7% determined by HPLC. Alternatively, the bisphenol A homopolycarbonate can be derived from a high purity bisphenol A monomer having a purity equal to or greater than 99.7% determined by HPLC.

The bisphenol A homopolycarbonate can have an M_{w} of 10,000 to 100,000 Da, specifically 15,000 to 50,000 Da, more specifically 17,000 to 35,000 Da, as measured by gel permeation chromatography (GPC), using a crosslinked styrene-divinylbenzene column and calibrated to polystyrene references.

The bisphenol A homopolycarbonate can be present in an amount of 10 to 90 wt %, preferably 10 to 80 wt %, 10 to 60 wt %, 15 to 50 wt %, or 20 to 45 wt %, based on the total weight of the thermoplastic composition.

The thermoplastic composition can further include an epoxy additive, for example as a chain extender to improve molecular weight stability of the thermoplastic composition after hydro aging or autoclaving. Exemplary epoxy compounds include epoxy modified acrylic oligomers or polymers (such as a styrene-acrylate-epoxy polymer, prepared from for example a combination of: a substituted or unsubstituted styrene such as styrene or 4-methylstyrene; an acrylate or methacrylate ester of a C₁₋₂₂ alkyl alcohol such as methyl acrylate, methyl methacrylate, ethyl acrylate, butyl acrylate, or the like; and an epoxy-functionalized acrylate such as glycidyl acrylate, glycidyl methacrylate, 2-(3,4-epoxycyclohexyl)ethyl acrylate, 2-(3,4-epoxycyclohexyl)ethyl methacrylate, or the like), or an epoxy carboxylate oligomer based on cycloaliphatic epoxides (such as, for example, 3,4-epoxycyclohexylmethyl-3,4-epoxycyclohexylcarboxylate, or the like). Epoxy additives can be used in amounts of up to 1 wt %, specifically 0.001 to 1 wt %, more specifically 0.001 to 0.5 wt %, based on the total weight of the thermoplastic composition.

The thermoplastic compositions can include other additives ordinarily incorporated into polymer compositions of this type, with the proviso that the additive(s) are selected so as to not significantly adversely affect the desired properties of the thermoplastic composition, in particular melt flow, thermal, transparency, and surface properties. The additive composition can include an impact modifier, flow modifier, filler (e.g., a particulate polytetrafluoroethylene (PTFE), glass, carbon, mineral, or metal), reinforcing agent (e.g., glass fibers), antioxidant (e.g., phosphites, polyphenols, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g, a dye or pigment), surface effect additive, radiation stabilizer, flame retardant, anti-drip agent (e.g., a PTFE-encapsulated styrene-acrylonitrile copolymer (TSAN)), or a combination thereof. The total amount of the additive composition (other than any impact modifier, filler, or reinforcing agent) can be 0.001 to 10.0 wt %, or 0.01 to 5 wt %, each based on the total weight of the polymer in the composition.

The thermoplastic compositions can be manufactured by various methods known in the art. For example, powdered polycarbonate, and other optional components are first blended, optionally with any fillers, in a high speed mixer or by hand mixing. The blend is then fed into the throat of a twin-screw extruder via a hopper. Alternatively, at least one of the components can be incorporated into the composition by feeding it directly into the extruder at the throat or downstream through a sidestuffer, or by being compounded into a masterbatch with a desired polymer and fed into the extruder. The extruder is generally operated at a temperature higher than that necessary to cause the composition to flow. The extrudate can be immediately quenched in a water bath and pelletized. The pellets so prepared can be one-fourth inch long or less as desired. Such pellets can be used for subsequent molding, shaping, or forming.

The thermoplastic compositions can have a low residual impurity content, in particular less than 2 ppm by weight of each of lithium, sodium, potassium, calcium, magnesium, ammonium, chloride, bromide, fluoride, nitrite, nitrate, phosphite, phosphate, sulfate, acetate, citrate, oxalate, trimethylammonium, and triethylammonium. It is to be understood that the foregoing residual impurities can exist in the thermoplastic compositions in non-ionized form (for example as triethylamine or formic acid), but the amounts on are determined based on cation.

The thermoplastic composition can be molded under standard molding conditions in range of 300 to 350° C. depending on the glass transition temperature of the composition. For example, the thermoplastic composition can be molded at 100 to 175° C. above the glass transition temperature of the polycarbonate composition for a residence time of 2 to 20 minutes.

The thermoplastic composition can have a glass transition temperature of 150° C. or higher, preferably 155 to 280° C., more preferably 165 to 260° C., even more preferably 185 to 230° C., determined by differential scanning calorimetry (DSC) as per ASTM D3418 with a 20° C./min heating rate.

The molded samples of the thermoplastic composition can have a haze less of less than 15%, more preferably less than 10%, more preferably less than 5%, even more preferably less than 1%, and a transmission greater than 85%, more preferably greater than 87%, more preferably greater than 89%, even more preferably greater than 90%, each measured according to ASTM D1003-00 using the color space CIE1931 (Illuminant C and a 2° observer) at a 2.5 mm thickness. The molded sample is prepared as described above.

The thermoplastic composition can have a transmission at wavelength of 1,000 nm of greater than 87%, preferably greater than 88%, more preferably greater than 89%. The thermoplastic composition can have a transmission at wavelength of 1,250 nm of greater than 87%, preferably greater than 88%, more preferably greater than 89%. The thermoplastic composition can have a transmission at wavelength of 1,560 nm of greater than 85%, preferably greater than 86%, more preferably greater than 87%. Transmission can be measured with a Perkin Elmer 950 spectrometer equipped with 15 cm integrated sphere on 2.5 mm.

The thermoplastic composition can have a yellowness index (YI) of less than 20, preferably less than 10, more preferably less than 5, even more preferably less than 3, as measured by ASTM D1925 on a 2.5 mm molded plaque.

The thermoplastic composition can have an increase in YI of less than 10, preferably less than 5, more preferably less than 3, during 2,500 hours of heat aging at 140° C., as measured by ASTM D1925 on a 2.5 mm thick molded plaque. The thermoplastic composition can have an increase in YI of less than 20, preferably less than 10, more preferably less than 5, during 2,500 hours of heat aging at 150° C., as measured by ASTM D1925 on a 2.5 mm thick molded plaque. The thermoplastic composition can have an increase in YI of less than 20, preferably less than 10, more preferably less than 5, during 10.00 hours of heat aging at 160° C., as measured by ASTM D1925 on a 2.5 mm thick molded plaque. The thermoplastic composition can have an increase in YI of less than 20, preferably less than 10, more preferably less than 5, during 500 hours of heat aging at 170° C., as measured by ASTM D1925 on a 2.5 mm thick molded plaque.

The thermoplastic composition can have an increase in YI of less than 5, preferably less than 3, more preferably less than 1, after 1,000 hours of hydro ageing at 80° C. and 85% relative humidity, as measured by ASTM D1925 on a 2.5 mm thick molded plaque.

The thermoplastic composition can have an increase in YI of less than 2, preferably less than 1, after 100 hours of autoclaving at 121° C., as measured by ASTM D1925 on a 2.5 mm thick molded plaque. The thermoplastic composition can have an increase in YI of less than 5, preferably less than 3, more preferably less than 1, after 100 hours of autoclaving at 134° C., as measured by ASTM D1925 on a 2.5 mm thick molded plaque. The thermoplastic composition can have an increase in YI of less than 10, preferably less than 5, more preferably less than 3, after 100 hours of autoclaving at 140° C., as measured by ASTM D1925 on a 2.5 mm thick molded plaque.

Shaped, formed, or molded articles including the thermoplastic compositions are also provided. The compositions can be molded into shaped articles by a variety of methods, such as part production via multi-cavity tools; molding such as injection molding, gas assist injection molding, micro molding, vacuum molding, over-molding, compression molding, rotary molding, heat/cool molding, transfer molding, or cavity molding; thermoforming; extruding; calendaring; casting; or the like. The article can be a molded article, a thermoformed article, an extruded film, an extruded sheet, one or more layers of a multi-layer article, a three dimensional (3D) printed part, a substrate for a coated article, or a substrate for a metallized article made from the thermoplastic composition.

Exemplary articles include a lens or cover for lighting devices, a lens holder, motor vehicle headlights, automotive rear lights, automotive fog lights, flash lights, cameras, mobile phone cameras; a light guide, a substrate film, a signal indicator, a waveguide element, a reflector, a collimator, a housing for a light source, a lamp bezel, a lamp holder, a lamp cover, a display screen, glazing, a safety goggle, a visor, a medical device, a face shield, an optical fiber, a fuse, a part of a domestic appliance, a window or door for domestic appliances, computer and business machine housings such as housings for monitors, handheld electronic device housings such as housings for cell phones, electrical connectors, a fire shield, a food tray, a packaging film, an animal cage, a tray, an optical film, a light bulb, a capacitor film, or a film laminate.

Other examples of articles include a flash lens, a camera lens, a mobile phone camera lens, a tablet camera lens, a laptop camera lens, a sensor lens, a proximity sensor lens, a gesture control lens, an infrared sensor lens, a scanner lens, an illumination device lens, a safety glass lens, an ophthalmic corrective lens, a projector lens, an imaging lens, an auto lens, a security camera lens, an automotive camera lens, an automotive sensing lens, a motion detector lens, a vehicle headlamp lens, a vehicle foglight lens, a vehicle rearlight lens, a camera sensor lens, an LED lens, a helmet, a respirator, a mask, a protective system, a shielding system, a syringe, blood filter housing, blood bag, solution bag, intravenous connector, dialyzer, catheter, medical storage tray, medical appliance, medical tubing, cardiac pacemaker and defibrillator, cannula, implantable prosthesis, cardiac assist device, heart valve, vascular graft, extra-corporeal device, artificial organ, pacemaker lead, defibrillator lead, blood pump, balloon pump, A-V shunt, biosensor, membrane for cell encapsulation, wound dressing, artificial joint, orthopedic implant and syringe, food tray, animal cage, cable sheathing, structural component for pumps and vehicles, mining ore screen and conveyor belt, aeronautical component, chocolate mold, watercooker component, washer component, dishwasher component, or dishwasher safe article, a microwave, an oven door, a touch sensor, packaging, a label, a gas barrier, an anti-fog assembly, an anti-reflective assembly, an encapsulant, a photovoltaic panel, a sensor, a window, a computer screen, a liquid crystal display screen, a screen for a hand-held electronic devise, or an organic light-emitting diode display screen.

Advantageously, the articles have no significant part distortion or discoloration when subjected to a secondary operation such as over-molding, lead-free soldering, low temperature soldering, coating with high temperature curing, or a combination thereof.

This disclosure is further illustrated by the following examples, which are non-limiting.

### EXAMPLES

The materials used in the Examples are described in Table 1.

TABLE 1

| Component | Chemical Description | Source |
|---|---|---|
| PPPBP | 2-phenyl-3,3-bis(4-hydroxyphenyl)phthalimide | SABIC |
| | (CAS Reg. No. 6607-41-6) | |
| RPBP | 2-phenyl-3-(dihydroxyfluoresceinyl)phthalimidine | SABIC |
| HHPC | N-phenylphenolphthaleinylbisphenol, 2,2-bis(4-hydro)-bisphenol A | SABIC |
| | polycarbonate copolymer, 25 mol % PPPBP, M_{w} = 21-25 kDa as | |
| | determined by GPC using polystyrene standards, para-cumylphenol | |
| | (PCP) end-capped | |
| BPA | Bisphenol A | SABIC |
| BMSC | Bis(methyl salicyl)carbonate (CAS Reg. No. 82091-12-1) | SABIC |
| NaOH | Sodium hydroxide | Sigma-Aldrich |
| TMAH | Tetramethylammonium hydroxide, 25 wt % solution in water | Sigma-Aldrich |

The weight average molecular weight (M_{w}) and number average molecular weight (Mₙ) of the copolycarbonates were determined by gel permeation chromatography (GPC), using a crosslinked styrene-divinylbenzene column and calibrated to bisphenol A homopolycarbonate references. GPC samples were prepared at a concentration of 1.5 mg per milliliter (mL), and are eluted at a flow rate of 1 mL per minute.

The molar percent of the copolymer units were determined by proton nuclear magnetic resonance spectroscopy (¹H-NMR).

Glass transition temperature (T_{g}) was determined using differential scanning calorimetry (DSC).

### Example 1

An exemplary composition was prepared by an exemplary melt polymerization process. A glass tube was charged with 35 grams (g) of BMSC, 15.83 g of BPA, 13 g of RPBP, and an aqueous solution of NaOH and TMAH in an amount corresponding to 0.005 millimoles (mmol) of NaOH and 0.15 mmol of TMAH per the number of moles of BPA and RPBP combined. After nitrogen purging of the glass tube, the temperature-pressure regimen used to carry out the melt polymerization comprised the steps of heating for the indicated time periods at the indicated temperatures and pressures shown in Table 2 below. After the final reaction stage, the glass tube was brought back to atmospheric pressure and copolycarbonate sample was recovered by breaking glass tube.

TABLE 2

| | | | | Time |
|---|---|---|---|---|
| Stage | Reactor (° C.) | Condenser (° C.) | Pressure (mbar) | (Minutes) |
| 1 | 180 | 120 | 915 | 15 |
| 2 | 220 | 120 | 915 | 15 |
| 3 | 250 | 120 | 100 | 15 |
| 4 | 315 | 120 | ambient | 7.5 |

The resulting RPBP-BPA copolycarbonate was further characterized by ¹H-NMR in CDCl₃: chemical shifts δ=8.0 ppm (2H), 7.54-7.50 ppm (m, 4H), 7.25-7.13 ppm (m, 47H), 6.95-6.92 ppm (m, ˜85H), 1.67 ppm (s, ˜44H), and 1.55 ppm (s, 10H). The ¹H-NMR spectrum for Example 1 indicates the copolycarbonate includes about 29 mol % of RPBP units.

### Comparative Example 1

The same procedure as Example 1 was used, except 13.42 g of PPPBP was used instead of RPBP and the melt polymerization followed the conditions shown in Table 3.

TABLE 3

| | Reactor | Condenser | | Time |
|---|---|---|---|---|
| Stage | Reactor (° C.) | Condenser (° C.) | Pressure (mbar) | (Minutes) |
| 1 | 180 | 120 | 915 | 15 |
| 2 | 220 | 120 | 915 | 15 |
| 3 | 230 | 120 | 100 | 15 |
| 4 | 300 | 120 | ambient | 7.5 |

The resulting PPPBP-BPA copolycarbonate was further characterized by ¹H-NMR in CDCl₃: chemical shifts 8=7.56 ppm (2H), 7.30 ppm (4H), 7.28-7.16 ppm (m, 47H), 6.95-6.92 ppm (m, 5H), and 1.71 ppm (s, 23H). The ¹H-NMR spectrum for Comparative Example 1 indicates the copolycarbonate includes about 33 mol % of PPPBP units.

Table 4 summarizes the M_{w}, Mₙ, T_{g}, and subunit composition.

TABLE 4

| | M_{w} (kDa) | Mₙ (kDa) | T_{g} (° C.) | Subunit composition |
|---|---|---|---|---|
| Example 1 | 28.928 | 13.572 | 196 | 29 mol % RPBP |
| Comparative | 40.444 | 18.631 | 183 | 33 mol % PPPBP |
| Example 1 | | | | |
| HHPC | 21-25 | — | 182 | 25 mol % PPPBP |

This disclosure further encompasses the following aspects.

Aspect 1: A thermoplastic composition comprising a copolycarbonate comprising bisphenol A carbonate units and second carbonate units of formula (1a) as provided herein, wherein R is a C₁₋₂₅ hydrocarbyl, preferably a C₁₋₆ alkyl, a phenyl, or a phenyl substituted with up to five C₁₋₆ alkyl groups, more preferably a C₁₋₃ alkyl or a phenyl; each occurrence of R² and R³ is independently a halogen or a C₁₋₂₅ hydrocarbyl, preferably a halogen or a C₁₋₆ alkyl, more preferably a C₁₋₃ alkyl; p is 0 to 4, preferably 0 or 1, more preferably 0; and each q is independently 0 to 3, preferably 0 or 1, more preferably 0; and optionally a bisphenol A homopolycarbonate.

Aspect 1a: The thermoplastic composition of Aspect 1, wherein R is a C₁₋₆ alkyl, a phenyl, or a phenyl substituted with up to five C₁₋₆ alkyl groups, more preferably a C₁₋₃ alkyl or a phenyl; each occurrence of R² and R³ is independently a halogen or a C₁₋₆ alkyl, more preferably a C₁₋₃ alkyl; p is 0 or 1, more preferably 0; and each q is independently 0 or 1, more preferably 0.

Aspect 2: The thermoplastic composition of Aspect 1, wherein the second carbonate units in the copolycarbonate are of formula (1b) as provided herein, wherein each occurrence of R¹ is independently a phenyl or a C₁₋₆ alkyl, preferably a C₁₋₃ alkyl; each occurrence of R² and R³ is independently a halogen or a C₁₋₂₅ hydrocarbyl, preferably a C₁₋₆ alkyl, more preferably a C₁₋₃ alkyl; p is 0 to 4, preferably 0 or 1, more preferably 0; and each q is independently 0 to 3, preferably 0 or 1, more preferably 0; and r is 0 to 5, preferably 0 or 1, more preferably 0.

Aspect 2a: The thermoplastic composition of any one or more of the preceding aspects, wherein R¹ is a C₁₋₃ alkyl; each occurrence of R² and R³ is independently a C₁₋₆ alkyl; p is 0 or 1; each q is independently 0 or 1; and r is 0 or 1.

Aspect 3: The thermoplastic composition of Aspect 1 or 2, wherein the second carbonate units in the copolycarbonate are of formula (1c) as provided herein.

Aspect 4: The thermoplastic composition of any one or more of the preceding aspects, wherein the copolycarbonate comprises, based on the total number of carbonate units in the copolycarbonate, 5-95 mol %, preferably 25-85 mol %, more preferably 50-80 mol % of the bisphenol A carbonate units; and 5-95 mol %, preferably 15-75 mol %, more preferably 20-50 mol % of the second carbonate units.

Aspect 4a: The thermoplastic composition of any one or more of the preceding aspects, wherein the copolycarbonate comprises, based on the total number of carbonate units in the copolycarbonate, 25 to 85 mole percent of the bisphenol A carbonate units; and 15 to 75 mole percent of the second carbonate units.

Aspect 5: The thermoplastic composition of any one or more of the preceding aspects, wherein the copolycarbonate further comprises high heat carbonate unit different from the bisphenol A carbonate unit and the second carbonate unit, the high heat carbonate unit comprising one or more of formulas (7) to (11) as provided herein, wherein R^{c} and R^{d} are each independently a C₁₋₁₂ alkyl, C₁₋₁₂ alkenyl, C₃₋₈ cycloalkyl, or C₁₋₁₂ alkoxy, each R⁶ is independently C₁₋₃ alkyl or phenyl, preferably methyl, X^{a} is a C₆₋₁₂ polycyclic aryl, C₃₋₁₈ mono- or polycycloalkylene, C₃₋₁₈ mono- or polycycloalkylidene, -(Q¹)ₓ-G-(Q²)_{y}- group wherein Q¹ and Q² are each independently a C₁₋₃ alkylene, G is a C₃₋₁₀ cycloalkylene, x is 0 or 1, and y is 1, or —C(P¹)(P²) wherein P¹ is C₁₋₁₂ alkyl and P² is C₆₋₁₂ aryl; each m is independently 0 to 3; preferably 0 or 1, more preferably 0; each n is independently 0 to 5; preferably 0 or 1, more preferably 0; and each q is independently 0 to 4; preferably 0 or 1, more preferably 0.

Aspect 6: The thermoplastic composition of Aspect 5, wherein the copolycarbonate comprises, based on the total number of carbonate units in the copolycarbonate, 40-80 mol %, preferably 50-80 mol %, more preferably 50-70 mol % of the bisphenol A carbonate units; 10-50 mol %, preferably 20-50 mol %, more preferably 20-40 mol % of the second carbonate units; and 5-50 mol %, preferably 5-40 mol %, more preferably 5-30 mol % of the high heat carbonate units.

Aspect 6a: The thermoplastic composition of Aspect 6, wherein the copolycarbonate comprises, based on the total number of carbonate units in the copolycarbonate, 50 to 80 mole percent of the bisphenol A carbonate units; 20 to 50 mole percent of the second carbonate units; and 5 to 40 mole percent of the high heat carbonate units.

Aspect 7: The thermoplastic composition of any one or more of the preceding aspects, wherein the copolycarbonate has a glass transition temperature of 150° C. or greater, preferably 190° C. or greater, more preferably 195° C. or greater, as determined by DSC.

Aspect 8: The thermoplastic composition of any one or more of the preceding aspects, further comprising 10-90 wt % of a polycarbonate homopolymer.

Aspect 9: The thermoplastic composition of any one or more of the preceding aspects, further comprising a processing aid, a heat stabilizer, an ultraviolet light absorber, a colorant, a flame retardant, an impact modifier, mold release agent, a reinforcing agent, or a combination thereof.

Aspect 10: The thermoplastic composition of any one or more of the preceding aspects, wherein the composition further comprises an epoxy-containing polymer, an epoxy-containing oligomer, or a combination thereof, preferably the composition further comprises a styrene-acrylate-epoxy polymer, or an epoxy carboxylate polymer, or a combination thereof.

Aspect 10a: The thermoplastic composition of any one or more of the preceding aspects, wherein the copolycarbonate comprises, based on the total number of carbonate units in the copolycarbonate, 25 to 40 mole percent of the second carbonate units; the copolycarbonate has a weight average molecular weight of 18,000 to 35,000 Daltons, as measured by gel permeation chromatography; and a glass transition temperature of 190 to 230° C., as measured by differential scanning calorimetry as per ASTM D3418 with a 20° C./min heating rate.

Aspect 11: An article manufactured from the composition of any one or more of the preceding aspects, wherein the article is a molded article, a thermoformed article, an extruded film, an extruded sheet, one or more layers of a multi-layer article, a three dimensional printed part, a substrate for a coated article, or a substrate for a metallized article.

Aspect 12: The article of Aspect 11, wherein the article is a lens or cover for lighting devices, a lens holder, motor vehicle headlights, automotive rear lights, automotive fog lights, flash lights, cameras, mobile phone cameras; a light guide, a substrate film, a signal indicator, a waveguide element, a reflector, a collimator, a housing for a light source, a lamp bezel, a lamp holder, a lamp cover, a display screen, glazing, a safety goggle, a visor, a medical device, a face shield, an optical fiber, a fuse, a part of a domestic appliance, a housings for a monitor, a housing for a cell phone, an electrical connector, a fire shield, a food tray, a packaging film, an animal cage, a tray, an optical film, a light bulb, a capacitor film, or a film laminate.

Aspect 13: The article of Aspect 11 or 12, wherein the article has no significant part distortion or discoloration when the article is subjected to over-molding, lead-free soldering, low temperature soldering, micro molding, or coating, or a combination thereof.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically, 5-20 wt %”, is inclusive of the endpoints and all intermediate values of the ranges of “5 wt % to 25 wt %,” etc.). “Combinations” is inclusive of blends, mixtures, alloys, reaction products, and the like. The terms “a” and “an” and “the” refer to both the singular and the plural, unless otherwise indicated or clearly contradicted by context. “Or” means “and/or” unless clearly stated otherwise. Reference throughout the specification to “some aspects”, “an aspect”, and so forth, means that a particular element described in connection with the aspect is included in at least one aspect described herein, and may or may not be present in other aspects. As used herein, “a combination thereof” is an open term that includes any combination of the listed components and can further include other components that are similar.

Unless otherwise specified, all test standards are the most recent standard in effect as of the filing date of the earliest priority application in which the test standard appears. Unless defined otherwise, technical and scientific terms used herein have the same meaning as is commonly understood by one of skill in the art to which this application belongs.

As used herein the term “hydrocarbon” refers to any compound or group including carbon and hydrogen. “Hydrocarbyl” as used herein refers to a monovalent moiety formed by removing a hydrogen atom from a hydrocarbon. The term “alkyl” means a branched or straight chain, unsaturated aliphatic hydrocarbon group (e.g., methyl, t-butyl, n-pentyl). “Alkenyl” means a straight or branched chain, monovalent hydrocarbon group having at least one carbon-carbon double bond. “Alkoxy” means an alkyl group that is linked via an oxygen (e.g., methoxy). “Alkylene” means a straight or branched chain, divalent alkyl group. “Cycloalkylene” means a divalent cyclic alkylene group. “Cycloalkenyl” means a monovalent group having one or more rings and one or more carbon-carbon double bonds in the ring, wherein all ring members are carbon. “Aryl” means an aromatic hydrocarbon group containing the specified number of carbon atoms (e.g., phenyl). “Aryloxy” means an aryl group that is linked via an oxygen. “Arylene” means a divalent aryl group. “Alkylarylene” means an arylene group substituted with an alkyl group. “Arylalkylene” means an alkylene group substituted with an aryl group. The prefix “halo” means a group or compound including one more of a fluoro, chloro, bromo, or iodo substituent. The prefix “hetero” means that the compound or group includes at least one ring member that is a heteroatom (e.g., 1, 2, or 3 heteroatom(s)), wherein the heteroatom(s) is each independently N, O, S, Si, or P.

“Substituted” means that the compound, group, or atom is substituted with at least one (e.g., 1, 2, 3, or 4) substituents instead of hydrogen, where each substituent is independently nitro (—NO₂), cyano (—CN), hydroxy (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl, C₇₋₁₃ arylalkylene (e.g., benzyl), C₇₋₁₂ alkylarylene (e.g., toluyl), C₄₋₁₂ heterocycloalkyl, C₃₋₁₂ heteroaryl, C₁₋₆ alkyl sulfonyl (—S(═O)₂-alkyl), C₆₋₁₂ arylsulfonyl (—S(═O)₂-aryl), or tosyl (CH₃C₆H₄SO₂—), provided that the substituted atom's normal valence is not exceeded, and that the substitution does not significantly adversely affect the manufacture, stability, or desired property of the compound. When a compound is substituted, the indicated number of carbon atoms is the total number of carbon atoms in the compound or group, excluding those of any substituents. For example, a group having the formula —CH₂CH₂CN is a C₂ alkyl group substituted with a cyano substituent.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A thermoplastic composition comprising:
a copolycarbonate comprising bisphenol A carbonate units and second carbonate units of formula (1a) 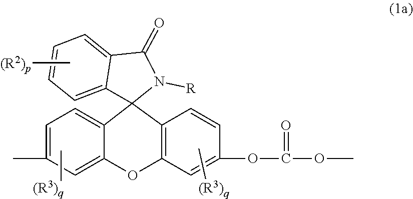
wherein
R is a C₁₋₂₅ hydrocarbyl;
each occurrence of R² and R³ is independently a halogen or a C₁₋₂₅ hydrocarbyl;
p is 0 to 4; and
each q is independently 0 to 3; and
optionally a bisphenol A homopolycarbonate.

2. The thermoplastic composition of claim 1, wherein
R is a C₁₋₆ alkyl, a phenyl, or a phenyl substituted with up to five C₁₋₆ alkyl groups;
each occurrence of R² and R³ is independently a halogen or a C₁₋₆ alkyl;
p is 0 or 1; and
each q is independently 0 or 1.

3. The thermoplastic composition of claim 1, wherein the second carbonate units in the copolycarbonate are of formula (1b) 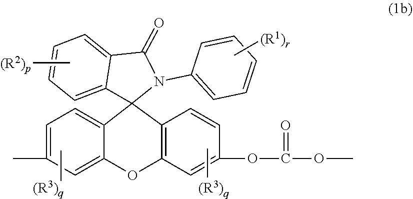
wherein
each occurrence of R¹ is independently a phenyl or a C₁₋₆ alkyl;
each occurrence of R² and R³ is independently a halogen or a C₁₋₂₅ hydrocarbyl;
p is 0 to 4;
each q is independently 0 to 3; and
r is 0 to 5.

4. The thermoplastic composition of claim 2, wherein
R¹ is a C₁₋₃ alkyl;
each occurrence of R² and R³ is independently a C₁₋₆ alkyl;
p is 0 or 1;
each q is independently 0 or 1; and
r is 0 or 1.

5. The thermoplastic composition of claim 1, wherein the second carbonate units in the copolycarbonate are of formula (1c)

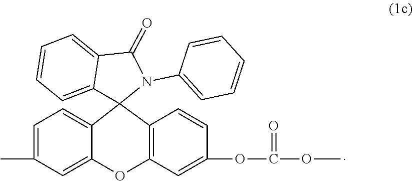

6. The thermoplastic composition of claim 1, wherein the copolycarbonate comprises, based on the total number of carbonate units in the copolycarbonate,
5 to 95 mole percent of the bisphenol A carbonate units; and
5 to 95 mole percent of the second carbonate units.

7. The thermoplastic composition of claim 1, wherein the copolycarbonate comprises, based on the total number of carbonate units in the copolycarbonate,
25 to 85 mole percent of the bisphenol A carbonate units; and
15 to 75 mole percent of the second carbonate units.

8. The thermoplastic composition of claim 1, wherein the copolycarbonate further comprises a high heat carbonate unit different from the bisphenol A carbonate unit and the second carbonate unit, the high heat carbonate unit comprising one or more of: 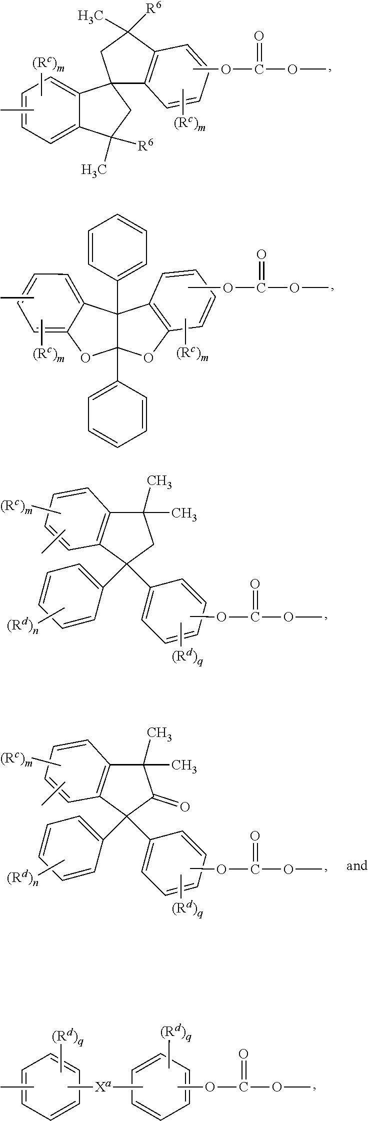
wherein
R^{c} and R^{d} are each independently C₁₋₁₂ alkyl, C₁₋₁₂ alkenyl, C₃₋₈ cycloalkyl, or C₁₋₁₂ alkoxy;
each R⁶ is independently C₁₋₃ alkyl or phenyl;
X^{a} is C₆₋₁₂ polycyclic aryl, C₃₋₁₈ mono- or polycycloalkylene, C₃₋₁₈ mono- or polycycloalkylidene, -(Q¹)ₓ-G-(Q²)_{y}- group wherein Q¹ and Q² are each independently C₁₋₃ alkylene, G is a C₃₋₁₀ cycloalkylene, x is 0 or 1, and y is 1, or —C(Z¹)(Z²) wherein Z¹ is C₁₋₁₂ alkyl or C₆₋₁₂ aryl and Z² is C₆₋₁₂ aryl;
each m is independently 0 to 3;
each n is independently 0 to 5; and
each q is independently 0 to 4.

9. The thermoplastic composition of claim 8, wherein the copolycarbonate comprises, based on the total number of carbonate units in the copolycarbonate,
40 to 80 mole percent of the bisphenol A carbonate units;
10 to 50 mole percent of the second carbonate units; and
5 to 50 mole percent of the high heat carbonate units.

10. The thermoplastic composition of claim 8, wherein the copolycarbonate comprises, based on the total number of carbonate units in the copolycarbonate,
50 to 80 mole percent of the bisphenol A carbonate units;
20 to 50 mole percent of the second carbonate units; and
5 to 40 mole percent of the high heat carbonate units.

11. The thermoplastic composition of claim 1, wherein the copolycarbonate has a glass transition temperature of 150° C. or greater, as determined by differential scanning calorimetry as per ASTM D3418 with a 20° C./min heating rate.

12. The thermoplastic composition of claim 1, further comprising a polycarbonate homopolymer in an amount of 10 to 90 weight percent based on the total weight of the thermoplastic composition.

13. The thermoplastic composition of claim 1, further comprising a processing aid, a heat stabilizer, an ultraviolet light absorber, a colorant, a flame retardant, an impact modifier, mold release agent, a reinforcing agent, or a combination thereof.

14. The thermoplastic composition of claim 1, wherein the composition further comprises an epoxy-containing polymer, an epoxy-containing oligomer, or a combination thereof.

15. The thermoplastic composition of claim 1, wherein
the copolycarbonate comprises, based on the total number of carbonate units in the copolycarbonate, 25 to 40 mole percent of the second carbonate units;
the copolycarbonate has a weight average molecular weight of 18,000 to 35,000 Daltons, as measured by gel permeation chromatography; and
a glass transition temperature of 190 to 230° C., as measured by differential scanning calorimetry as per ASTM D3418 with a 20° C./min heating rate.

16. The thermoplastic composition of claim 15, wherein the copolycarbonate has a weight average molecular weight of 24,000 to 32,000 Daltons, as measured by gel permeation chromatography.

17. A method for manufacturing the thermoplastic composition of claim 1, wherein the copolycarbonate is prepared by melt polymerization.

18. An article manufactured from the composition of claim 1, wherein the article is a molded article, a thermoformed article, an extruded film, an extruded sheet, one or more layers of a multi-layer article, a three dimensional printed part, a substrate for a coated article, or a substrate for a metallized article.

19. The article of claim 18, wherein the article is a lens or cover for lighting devices, a lens holder, motor vehicle headlights, automotive rear lights, automotive fog lights, flash lights, cameras, mobile phone cameras; a light guide, a substrate film, a signal indicator, a waveguide element, a reflector, a collimator, a housing for a light source, a lamp bezel, a lamp holder, a lamp cover, a display screen, glazing, a safety goggle, a visor, a medical device, a face shield, an optical fiber, a fuse, a part of a domestic appliance, a housings for a monitor, a housing for a cell phone, an electrical connector, a fire shield, a food tray, a packaging film, an animal cage, a tray, an optical film, a light bulb, a capacitor film, or a film laminate.

20. The article of claim 18, wherein the article has no significant part distortion or discoloration when the article is subjected to a secondary operation comprising over-molding, lead-free soldering, low temperature soldering, micromolding, or coating, or a combination thereof.
